(19) United States
(12) Patent Application Publication
(10) Pub. No.: US 2007/0238511 A1
(43) Pub. Date: Oct. 11, 2007

(54) GAMING MACHINE

(75) Inventor: Kazunobu Sato, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/696,336

(22) Filed: Apr. 4, 2007

(30) Foreign Application Priority Data
Apr. 10, 2006 (JP) 2006-107807

(51) Int. Cl. A63F 13/00

(52) U.S. Cl. 463/20

(57) ABSTRACT

In a gaming machine, a symbol display unit is provided to display a plurality of symbols respectively on a plurality of variable display portions. The plurality of symbols is varied in response to a start signal output from a start signal outputting unit. A plurality of symbols to be displayed on the plurality of variable display portions are determined as a determination result. An award is provided based on a combination of the plurality of symbols in the determination result. The gaming machine includes a symbol storage unit that stores a game history including the determination result that has been determined for at least one previous game. A privilege is provided based on a relationship between the determination result of a current game and the game history.

### CROSS-REFERENCE TO RELATED APPLICATIONS

This application is based upon and claims the benefit of priority from Japanese Patent Application No. 2006-107807, filed on Apr. 10, 2006, the entire contents of which are incorporated herein by reference.

### TECHNICAL FIELD

The present invention relates to a gaming machine, such as a slot machine capable of variably displaying symbols aligned in a plurality of arrays.

### BACKGROUND OF THE INVENTION

There is a gaming machine (for example, a slot machine or the like) that includes a rotatable reel (a variable display device) having a perimeter on which a symbol array is illustrated and performs a game variably displaying symbols by rotating the rotatable reel. There are various types of the variable display devices provided in this kind of gaming machine; one varies the symbols by mechanically rotating an actual rotatable reel, and another variably displays the symbols by simulating a rotation of the rotatable reel on an image display device such as a liquid crystal display device or a CRT (Cathode Ray Tube) display device.

This type of gaming machine, in general, changes a plurality of the variable display devices by inserting a medal or a coin (hereafter referred to as a “game medium”) and performing a predetermined start operation (e.g., a depression operation of a spin button). Then, based on a lottery result of an internal lottery, the gaming machine performs a stop process of a plurality of varying symbols. Thereafter, based on a combination of stopped symbols, a predetermined amount of the game medium is provided to a player.

JP-A-2001-87452 discloses a gaming machine that provides a special game (for example, a bonus game such as a free game) advantageous to the player when a stopped aspect of the symbols is a predetermined condition. According to this kind of gaming machine, there is a case of transferring to the special game, which can provide a large amount of the game medium, during a normal game, so that it is possible to prevent a gaming condition to be monotonous thus giving the player feelings of excitement and expectation.

The normal game and the special game in the above-described gaming machine are determined by a predetermined internal lottery process and the like performed at every game start. When the special game is established, the player can obtain a larger amount of the game medium. For this reason, a probability for establishing the special game in the internal lottery process is set low. As a result, a stimulus is provided to the player playing the game, which prevents the player from becoming bored with the game.

However, the gaming machine that executes the normal game and the special game in this way concludes a play in one game, and there is no connection with another game (a preceding or subsequent game). Therefore, it may lack an entertainment value. That is, the player shows an interest in only a displayed result of each game (only a result of a game presently being executed), so that the player does not maintain an interest over a duration of a certain time (for a plurality of games). From a point of view of the entertainment value, it can be considered that there is further room for improvement.

### SUMMARY OF THE INVENTION

According to an aspect of the invention, there is provided a gaming machine including: a symbol display unit configured to display a plurality of symbols respectively on a plurality of variable display portions; a start signal outputting unit configured to output a start signal to start a game; a symbol varying unit configured to vary the plurality of symbols displayed on the symbol display unit in response to the start signal; a symbol determination unit configured to determine a plurality of symbols to be displayed on the plurality of variable display portions as a determination result; an award providing unit configured to provide an award based on a combination of the plurality of symbols in the determination result; a symbol storage unit that stores a game history including the determination result that has been determined for at least one previous game, the previous game being performed before a current game; and a privilege providing unit configured to provide a privilege based on a relationship between the determination result of the current game and the game history.

### BRIEF DESCRIPTION OF THE DRAWINGS

FIG. 1 is a view showing an embodiment of a gaming machine according to the invention, which is an external perspective view showing a slot machine;

FIG. 2 is a view showing a configuration of variable display portions of a main display;

FIG. 3 is a view showing positions of activated pay lines;

FIG. 4 is a block diagram schematically showing a control system of the slot machine;

FIG. 5 is a block diagram showing an example of an internal configuration of an image control circuit;

FIG. 6 is a diagram showing a symbol arrangement table;

FIG. 7 is a diagram showing a symbol lottery table;

FIG. 8 is a diagram showing an example of data stored in an activated pay line symbol storage area;

FIG. 9 is a diagram showing an example of data stored in a symbol storage area;

FIG. 10 is a diagram showing an example of data stored in a game history storage area;

FIG. 11 is a diagram showing a winning combination determination table;

FIG. 12 is a diagram showing an example of data stored in a winning combination storage area;

FIG. 13 is a diagram showing a free game quantity lottery table;

FIG. 14 is a diagram showing an effect table;

FIG. 15 is a main flowchart showing an example of an implementation procedure of a game in the slot machine;

FIG. 16 is a flowchart showing an example of a medal insertion process procedure in the flowchart shown in FIG. 15;

FIG. 17 is a flowchart showing an example of a lottery process procedure in the flowchart shown in FIG. 15;

FIG. 18 is a flowchart showing an example of a winning combination search process procedure in the flowchart shown in FIG. 15;

FIG. 19 is a flowchart showing an example of a reel drive control process procedure in the flowchart shown in FIG. 15;

FIG. 20 is a flowchart showing an example of a free game process procedure in the flowchart shown in FIG. 15;

FIG. 21 is a view showing a display aspect of history information on a sub-display; and

FIG. 22 is a view showing a display aspect on the main display.

### DETAILED DESCRIPTION OF THE PREFERRED EMBODIMENTS

A detailed description of a gaming machine according to the invention will be described with reference to the drawings, based on an embodiment of the invention showing a slot machine as an example of the gaming machine.

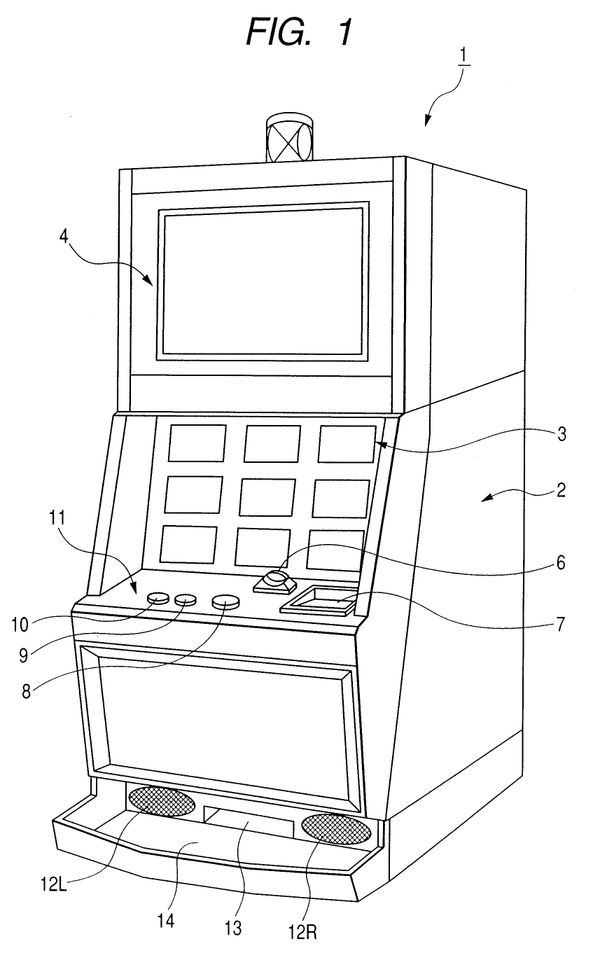

FIG. 1 is a perspective view showing an overall configuration of a slot machine, which is an example of a gaming machine. A slot machine 1 includes a cabinet 2 and a main display 3 equipped with a liquid crystal display device on a front surface of the cabinet 2. The slot machine 1 also includes a sub-display 4 likewise equipped with a liquid crystal display device in a portion above the main display 3.

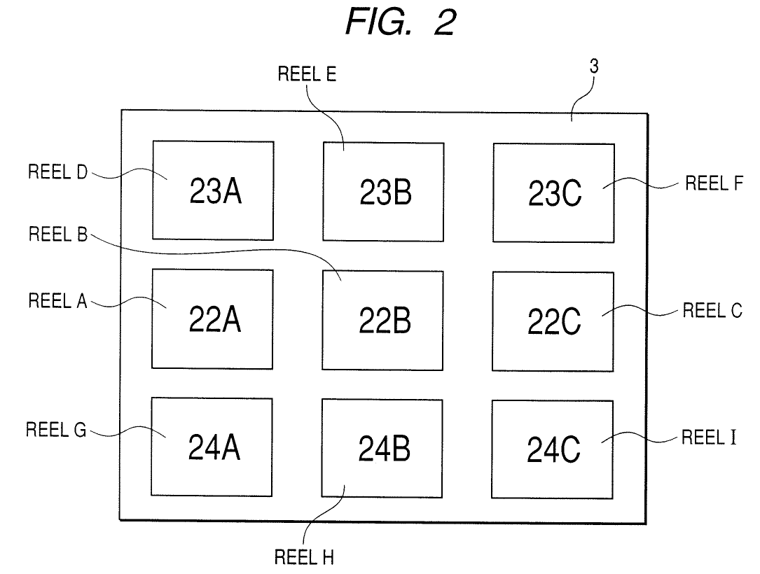

As shown in FIG. 2, the main display 3 includes the plurality of variable display portions (in this embodiment, a total of nine variable display portions 22A, 22B, 22C, 23A, 23B, 23C, 24A, 24B and 24C, disposed in three each of vertical and horizontal arrays) in a screen thereof, which is configured so that the player can perceive the plurality of variable display portions as one block. The main display 3 serves as a symbol display unit (described later) including a plurality of variable display portions that simulate a display of rotatable reels.

The main display 3 may include a transmissive touch sensitive panel to receive various kinds of input commands by the player touching the touch sensitive panel.

A normal game and a special game (also called a free game) that provides an award (e.g., a game medium) relatively advantageous to the player in comparison with the normal game are executed on the main display 3 by a game control unit (described later). In both the normal game and the special game, scroll display images (reel images reel A to reel I displayed exactly as though mechanical reels were rotating) are displayed in the variable display portions 22A to 22C, 23A to 23C and 24A to 24C. That is, the normal game is performed only when a bet is placed, but the special game is performed without placing the bet. The scroll display image presents a plurality of symbols moving from a top to a bottom. A payout amount of the game medium is determined in advance in accordance with a stopped symbol arrangement in the variable display portions.

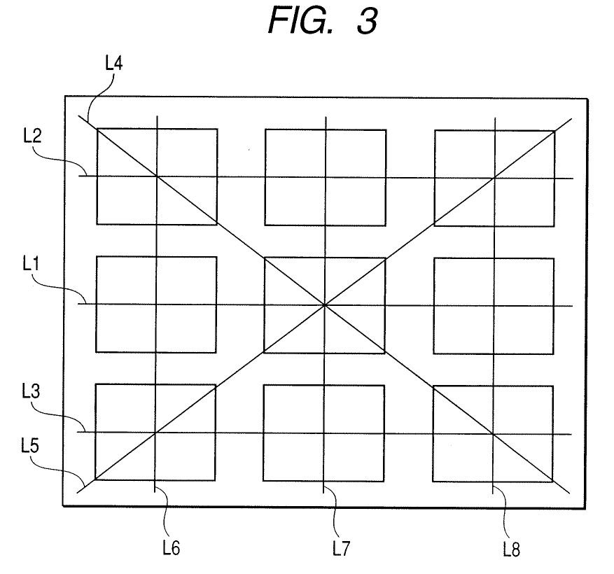

In the embodiment, the nine variable display portions 22A to 22C, 23A to 23C and 24A to 24C are arranged as described above, and a total of eight lines (L1 to L8) including the three each of the vertical and horizontal arrays and arrangements on diagonal lines are all set in one game regarding lines for determining a symbol arrangement (see FIG. 3).

The main display 3 may include an effect display area to display an image for perform effect of the game. For example, it is acceptable to dispose the effect display area in a peripheral area of the variable display portions, and to display therein various kinds of effect image, background image and the like which have no relationship with the variable displays simulating the rotatable reels in the variable display portions 22A to 22C, 23A to 23C and 24A to 24C. Naturally, it is also acceptable that an image display portion for displaying the effect image is disposed on an image display device, such as a liquid crystal display device, separate from the main display 3 and the sub-display 4.

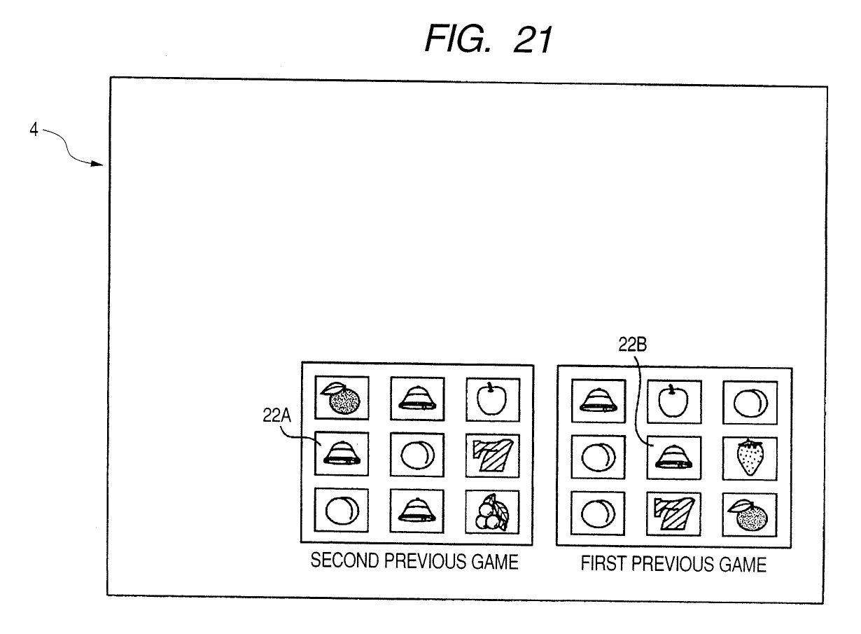

For example, the sub-display 4 displays thereon information related to the game and the like, such as a gaming method, a payout table indicating kinds of winning combination and their awards, various kinds of effect and the like. It is also acceptable to additionally display game history information and the like which display a symbol display result in one game for a duration of a plurality of games (see FIG. 21). Naturally, it is also acceptable that this portion simply includes a panel on which game details are indicated, rather than an image display device such as the liquid crystal display device.

An approximately horizontal pedestal portion 11 is provided below the main display 3. On the pedestal portion 11, a medal insertion slot 6, a bill accepter 7, a spin button 8, a 1 BET button 9 and a maximum BET button 10 are provided.

The medal insertion slot 6 is provided for the player to insert a game medium having a gaming value, such as a coin or a medal (the game medium is hereafter simply referred to as a “medal” in this embodiment) for betting on the game and includes an inserted medal sensor that outputs a signal indicating an insertion of the medal. Also, the bill accepter 7 is provided for the player to insert a bill as one game medium and includes an inserted bill sensor 7a that outputs a signal indicating an insertion of the bill.

The game medium may include a recording medium, such as a pre-paid card, which records information regarding the gaming value, in addition to the above described coin, the medal and the bill.

The spin button 8 including a function as a start signal outputting unit that instructs a start of a unit game based on a start operation of the player. By operating the spin button, a spin switch provided internally emits a detection signal so that the scroll display images of the symbols are displayed in the variable display portions 22A to 22C, 23A to 23C and 24A to 24C.

The 1 BET button 9 is provided for performing a setting of betting one medal by each operation. The maximum BET button 10 is provided for perform a setting of betting a maximum quantity of medals which can be bet on one game by each operation. The operation of these buttons is respectively detected by an internally provided 1 BET switch and maximum BET switch each of which emits a detection signal.

In the slot machine 1, a medal payout opening 13 and a medal receiving tray 14 are provided at a bottom of the housing 2. Furthermore, speakers 12L and 12R are respectively provided on a left side and a right side of the medal payout opening 13 to sandwich the medal payout opening 13.

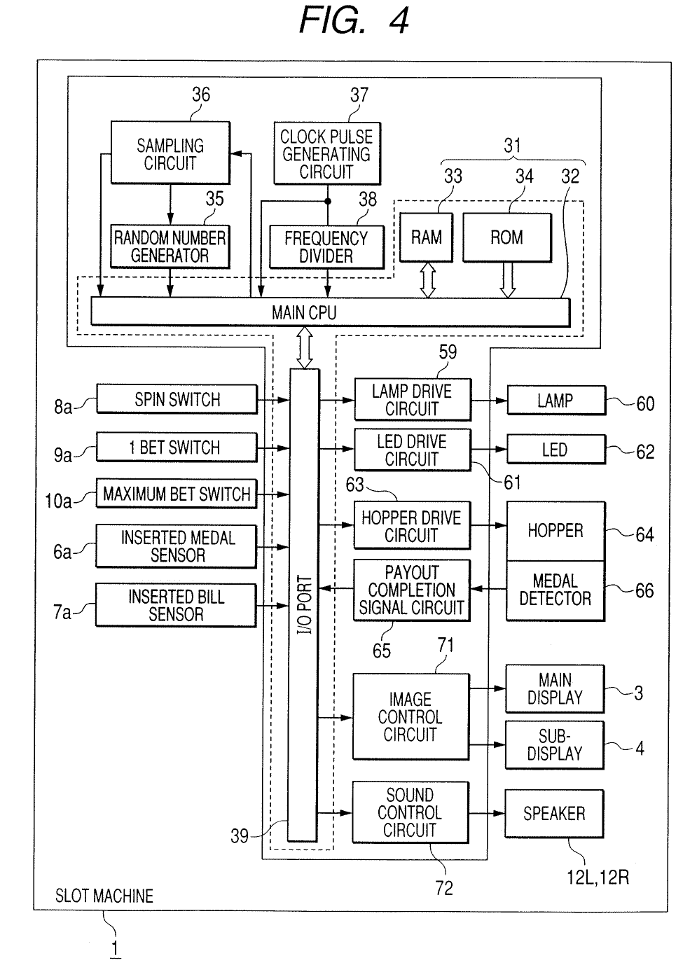

Next, the game control unit that controls a game operation of the slot machine 1 will be described with reference to FIG. 4. FIG. 4 is a block diagram schematically showing the game control unit that controls the game operation of the slot machine 1 and includes a plurality of components centered around a microcomputer 31.

The microcomputer 31 contains a main CPU (Central Processing Unit) 32, which is also a controller, an RAM (Random Access Memory) 33 and an ROM (Read Only Memory) 34. The main CPU 32 includes a function of a privilege providing unit.

The ROM 34 stores: various kinds of program for performing processes necessary for an implementation of the game, such as a main process, a medal insertion and start checking process, a reel drive control process, a lottery process, a winning combination search process and a free game process, all described later; and various kinds of data table such as a lottery table for selecting a stopped display symbol of the game. The RAM 33 includes a function as a storage unit that temporarily stores various kinds of data on which a calculation process has been performed in the main CPU 32; when the main CPU 32 operates in accordance with an operation program stored in the ROM 34, data and programs used are stored in the RAM 33. The RAM 33 includes a function as a game history storage unit (a symbol storage unit) which stores a game history; when operating in accordance with the operation program of the ROM 34, the main CPU 32 outputs a signal related to the payout amount based on the history information of the game history storage unit.

The programs, data and the like used when controlling the slot machine 1 are not limited to a case in which they are stored in advance in the ROM 34 or RAM 33, it is possible to change as appropriate. For example, it is also acceptable to have a configuration in which similar programs, data and the like are stored in a storage medium such as a non-volatile memory, e.g., a compact flash®, and downloaded from the storage medium onto the ROM 34 or the like. Also, it is acceptable to have a system to perform an authentication process or the like with a host computer and download this kind of program or the like.

A clock pulse generating circuit 37, which generates a standard clock pulse, and a frequency divider 38 are connected to the main CPU 32. Also, a random number generator 35 and a sampling circuit 36, which configure a lottery processing unit, are connected to the main CPU 32. The random number generator 35 operates in accordance with an instruction from the main CPU 32 and generates random numbers in a certain range. In accordance with an instruction from the main CPU 32, the sampling circuit 36 extracts an optional random number from among the random numbers generated by the random number generator 35 and inputs the extracted random number into the main CPU 32. The clock pulse generating circuit 37 generates the standard clock pulse for operating the main CPU 32, and the frequency divider 38 inputs a signal in which the standard clock pulse is divided by a certain frequency into the main CPU 32. The random number sampled via the sampling circuit 36 is used in various kinds of lottery of the winning combination or the like.

The main CPU 32 operates in accordance with the programs stored in the ROM 34 and receives a signal, via an I/O port 39, from the medal insertion slot 6 (the inserted medal sensor 6a), the bill accepter 7 (the inserted bill accepter 7a), the spin button 8 (the spin switch 8a), the 1 BET button 9 (the 1 BET switch 9a) or the maximum BET button 10 (the maximum BET switch 10a) provided in the pedestal portion 11. Based on the signal, the main CPU 32 performs an overall operation control accompanying the implementation of the game.

A lamp drive circuit 59, an LED drive circuit 61, a hopper drive circuit 63 and a payout completion signal circuit 65 are connected to the main CPU 32 via the I/O port 39. Also, the main CPU 32 is connected, via the I/O port 39, to an image control circuit 71, which controls display of an image to be displayed on the main display 3 and the sub-display 4, and a sound control circuit 72, which controls a sound output from the speakers 12L and 12R.

The lamp drive circuit 59 performs the effect of the game by outputting a signal to the lamps 60 for illuminating various kinds of lamp 60, for example, for causing the lamps 60 to flash during an execution of the game. The LED drive circuit 61 controls a flashing display of an LED 62 which performs a display of information necessary for the implementation of the game such as, for example, a credit quantity display or an acquired quantity display. The lamps 60 and the LED 62, although not shown in FIG. 1, are provided in a portion easily visible to the player.

The hopper drive circuit 63 drives the hopper 64 in accordance with a control of the main CPU 32. The hopper 64 performs an operation for a payout of the medal and pays the medal out into the medal payout opening 13. A medal detector 66 counts a number of coins paid out from the hopper 64 and notifies the payout completion signal circuit 65 of data of the counted number value. The payout completion signal circuit 65 receives the data of the medal number value from the medal detector 66. If the number value reaches data of a set number value, the payout completion signal circuit 65 outputs a signal informing of a medal payout completion to the main CPU 32.

The hopper drive circuit 63, the hopper 64, the medal detector 66 and the payout completion signal circuit 65, along with the main CPU 32, include a function as an award providing unit.

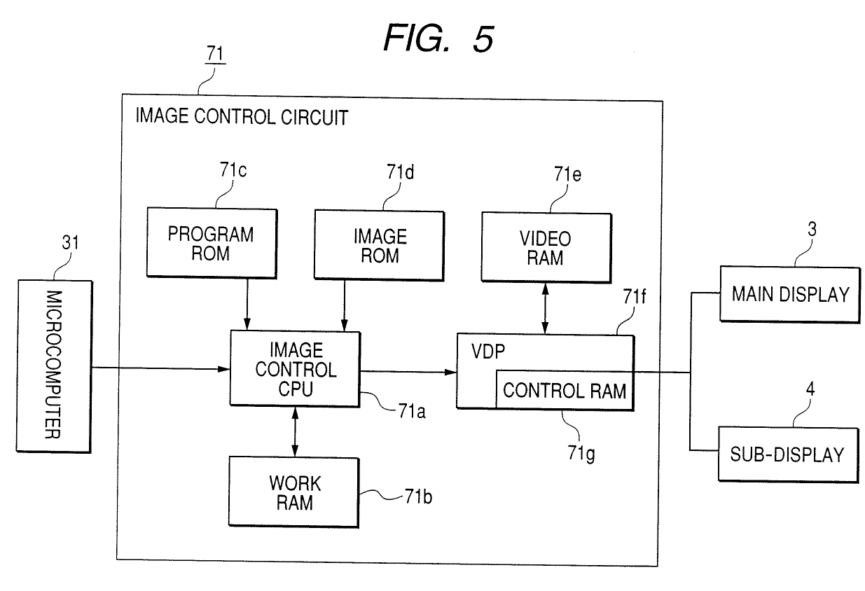

The image control circuit 71, which have a function as a symbol varying unit, controls an image display on each of the main display 3 and the sub-display 4 and allows various kinds of image, such as a scrolling image, to be displayed on the main display 3 and the sub-display 4. As shown in FIG. 5, the image control circuit 71 includes an image control CPU 71a, a work RAM 71b, a program ROM 71c, an image ROM 71d, a video RAM 71e and a VDP (Video Display Processor) 71f.

The image control CPU 71a, based on a parameter set by the microcomputer 31 and in accordance with an image control program stored in advance in the program ROM 71c, determines an image (a symbol image or the like) to be displayed on the main display 3 and the sub-display 4. The work RAM 71b is configured as a temporary storage unit used when the image control CPU 71a executes the image control program. The program ROM 71c stores the image control program and the various kinds of lottery table. The image ROM 71d stores dot data for forming the image. Data of the above various kinds of symbol image are included in the dot data.

The video RAM 71e is configured as a temporary storage unit used when the VDP 71f forms the image. The VDP 71f including a control RAM 71g forms images corresponding to display details of the main display 3 and the sub-display 4 determined by the image control CPU 71a and outputs the images formed to the main display 3 and the sub-display 4.

The sound control circuit 72 outputs a sound signal for outputting the sound from the speakers 12L and 12R. The sound is output from the speakers 12L and 12R in order to enliven the game at an appropriate point, for example, after a start of the game.

Next, the symbols used in the game of the slot machine 1 will be described.

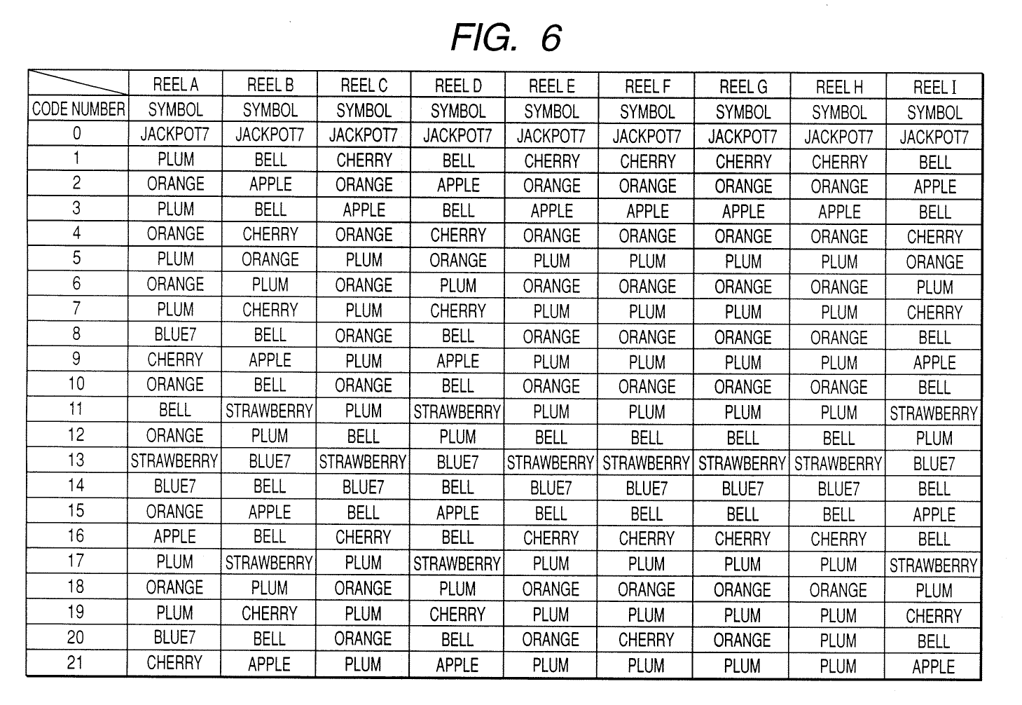

Each of the reel A to the reel I includes twenty-two symbols arrayed in a predetermined order, and as shown in FIG. 6, each symbol is allotted a code number from 0 to 21. The reel A to the reel I are cyclically scroll displayed in the variable display portions 22A to 22C, 23A to 23C and 24A to 24C of the main display 3, respectively. As a result, it presents the player exactly as though the mechanical reels were rotating and the symbols were changing.

The symbols stop displayed in the variable display portions 22A to 22C, 23A to 23C and 24A to 24C are determined by, for example, a symbol determination unit described later.

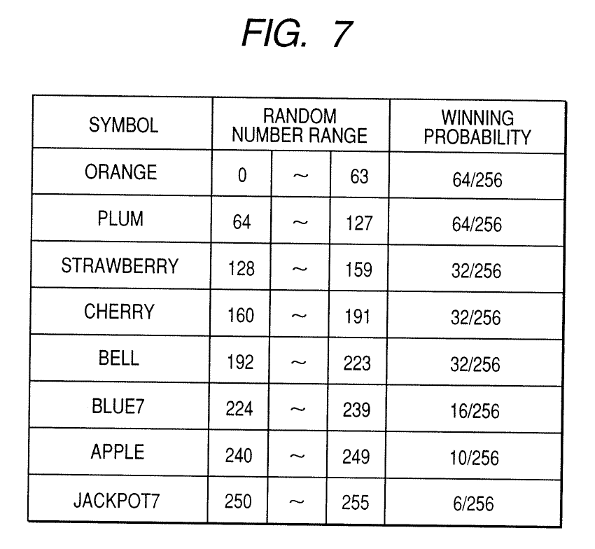

The main CPU 32 detects the start operation of the player (for example, the operation of the spin switch 8). In response to the detection (that is, takes the game start as an impetus), the main CPU 32 instructs the random number generator 35 to generate the random numbers in the certain range. Also, the main CPU 32 instructs the sampling circuit 36 to extract the optional random number from among the random numbers generated by the random number generator 35. After the random number is extracted, the main CPU 32 sets the random number in a search key and determines a symbol to be stopped by referring to a symbol lottery table (see FIG. 7) stored in the ROM 34.

Each of the symbols is associated with the code number, and the main CPU 32 obtains the code number of the symbol that has been determined based on the extracted random number value. Next, the main CPU 32 sets the obtained code number in a search key and searches for a stopped symbol to be stop-displayed in a corresponding variable display portion by referring to an image arrangement table (see FIG. 6) ordered by reel. For example, regarding the reel A in the variable display portion 22A, if an “ORANGE” symbol is determined by the random number value extracted in the image lottery table shown in FIG. 7, one of corresponding code numbers 2, 4, 6, 10, 12, 15 or 18 associated with the “ORANGE” symbol in advance is determined (the determination method is not particularly limited but, for example, a code number of a position nearest to the stopped symbol in a previous game is obtained).

The random number extraction, image lottery table search and image arrangement table search as described above are performed a total of nine times, once for each of the variable display portions 22A to 22C, 23A to 23C and 24A to 24C. That is, by performing the table searches a number of times corresponding to a quantity of the variable display portions, the stopped symbols in the variable display portions 22A to 22C, 23A to 23C and 24A to 24C are determined.

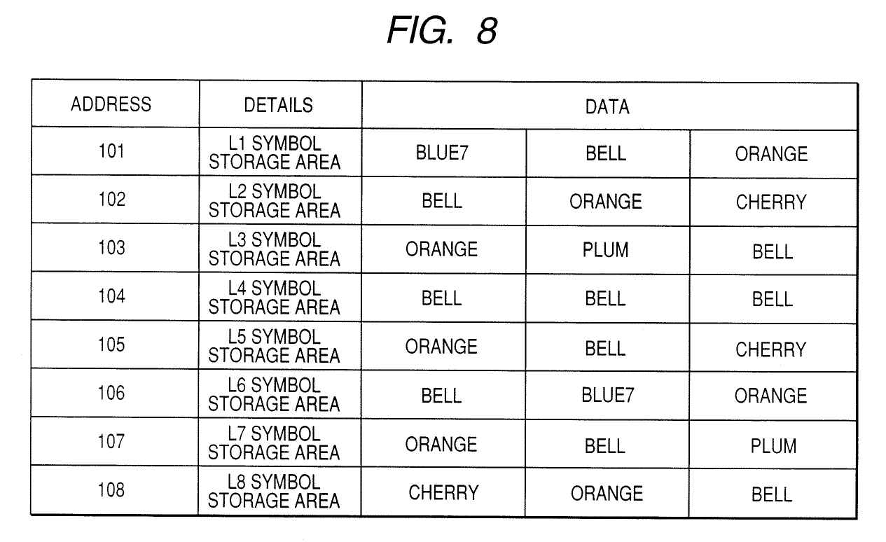

When the stopped symbol is determined for each of the variable display portions by the above described procedure, as shown in FIG. 8, the stopped symbol information is stored for each activated pay line with address information appended thereto in an activated pay line symbol storage area of the RAM 33. In order to simplify the explanation, FIG. 8 shows a storage example of a case where a stop control position of the reels positioned in the corresponding variable display portions is a code number 20 shown in FIG. 6.

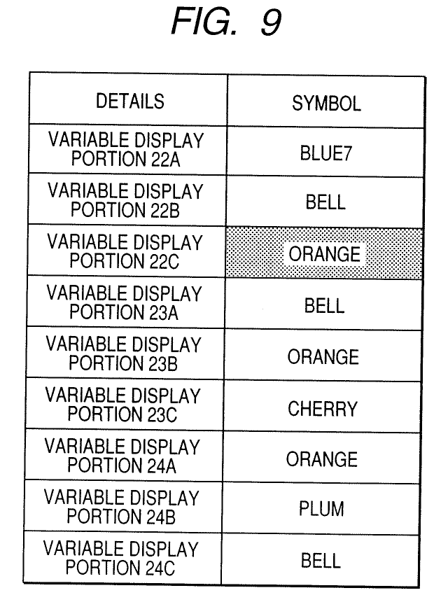

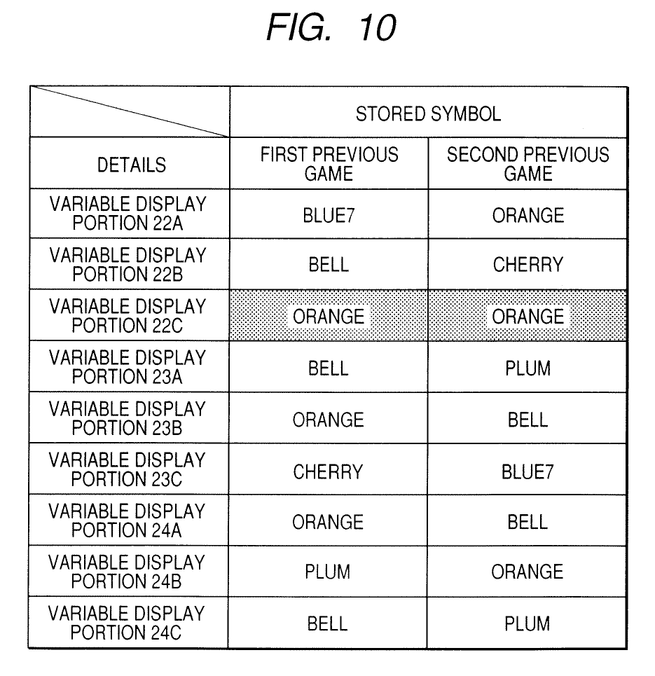

Also, when the stopped symbols is determined for each of the variable display portions, as shown in FIG. 9, the stopped symbol information is stored for each variable display portion in a symbol storage area of the RAM 33 (FIG. 9 also shows the storage example of the case where the stop control position of the reels positioned in each variable display portion is the code number 20 shown in FIG. 6, in order to simplify the explanation). As shown in FIG. 10, with regard to the symbol information stored in this way, the RAM 33 stores the stopped symbol information for each variable display portion with respect to preceding two games as the game history information in a game history storage area.

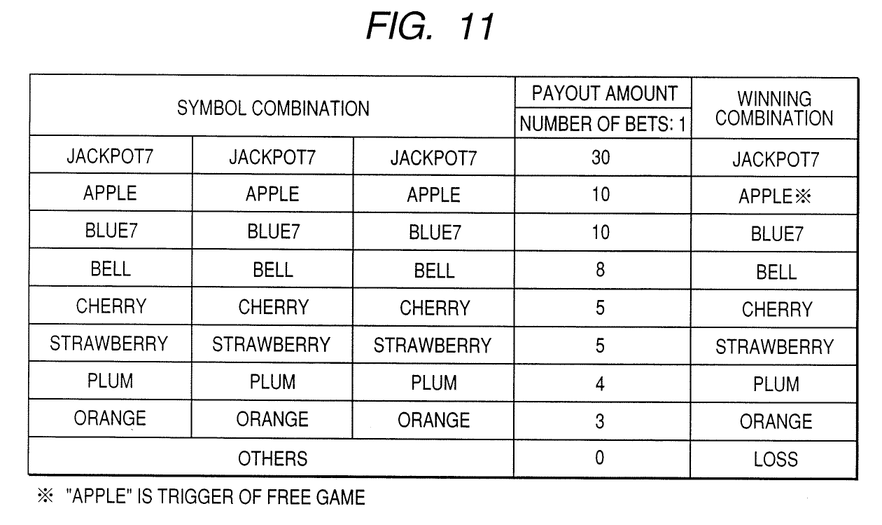

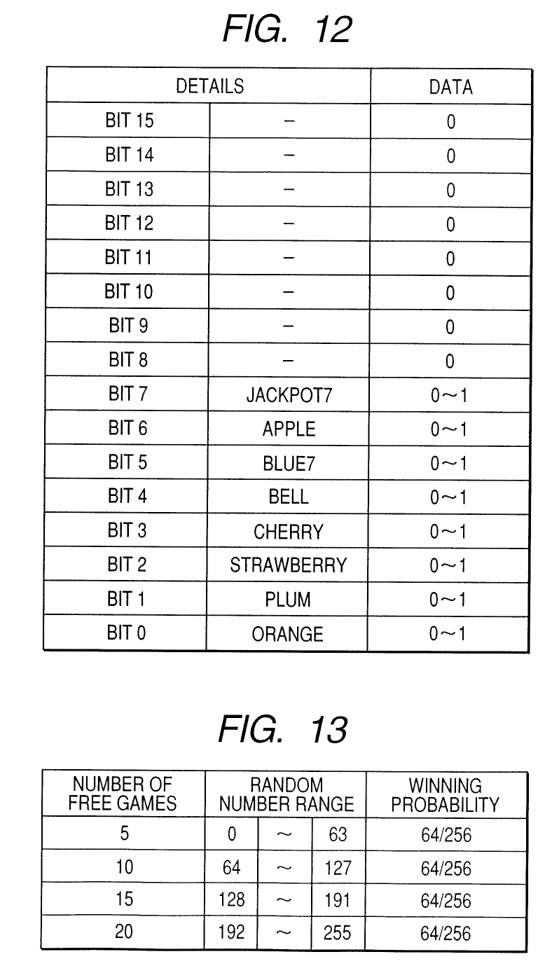

Then, based on the determined stopped symbol of each reel and referring to a winning combination determination table shown in FIG. 11, the main CPU 32 determines the winning combination. Herein, as shown in FIG. 8, since “BELL”s are aligned on the line L4 corresponding to an address 104, “BELL” is specified as the winning combination, and the payout amount of the game medium (in a case where a number of bets is one, the payout amount is eight) is determined. As shown in FIG. 12, the specified winning combination is stored, along with bit information, in a winning combination storage area of the RAM 33.

In the embodiment, a combination of “APPLE” symbols is a trigger for a transfer to the free game. When “APPLE” is established as the winning combination, a relatively large profit is provided to the player. The free game is, for example, of a special game aspect in which the above described game can be played a predetermined number of times without inserting the game medium. The player can receive a payment of the medal without reducing the number of medals or credits during this time and has a great advantage as regards a medal acquisition. Regarding the number of free games which can be executed, when “APPLE” is established as the winning combination, the lottery process is executed, and the main CPU 32 determines the number of games based on a free game quantity lottery table shown in FIG. 13.

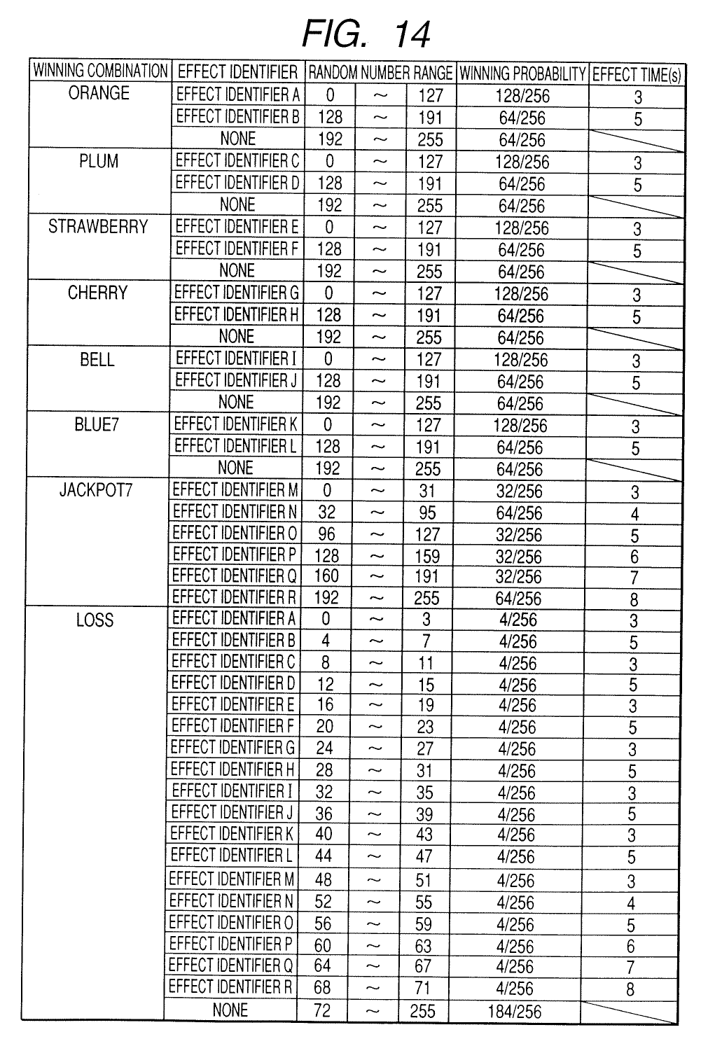

When the winning combination is determined as described above, effect corresponding to the winning combination is performed. The effect is determined in accordance with an effect table shown in FIG. 14 by the lottery process performed by the main CPU 32. Then, an effect image, stored in advance corresponding to an effect identifier determined by the lottery, is selected. Thereafter, the effect image is displayed for a predetermined time on an image display unit such as the main display 3 or the sub-display 4. Also, in addition to the effect by the image, it is also acceptable to perform effect related to the sound from the speakers 12L and 12R.

According to this embodiment, by obtaining a relationship the stopped symbols of the plurality of games, which are displayed in the variable display portions 22A to 22C, 23A to 23C and 24A to 24C, an interest is increased. In this embodiment, a relationship of the stopped symbols in the current game presently performed and the stopped symbols in the preceding two games is obtained, and if the relationship has become a predetermined aspect (a predetermined history aspect), a privilege is provided to the player.

Specifically, in the embodiment, the stopped symbols in the variable display portions are referring to for the preceding two games, and if it is determined that an identical symbol has stopped in any one variable display portion for three successive games, the symbol is specified as the winning combination. That is, even though identical symbols are not aligned along an activated pay line in the game presently being performed (a losing condition in the game), if the identical symbol has stopped in any one variable display portion for three successive games, the symbol is taken as the winning combination, and the profit is provided to the player.

Hereafter, a control method for controlling the implementation of the game in the slot machine 1 according to the embodiment will be described with reference to flowcharts. In the flowcharts shown hereafter, a step will be abbreviated to “S.” Also, the following processes are performed by the main CPU 32 executing information related to a slot game of the programs stored in the ROM 34 and the RAM 33.

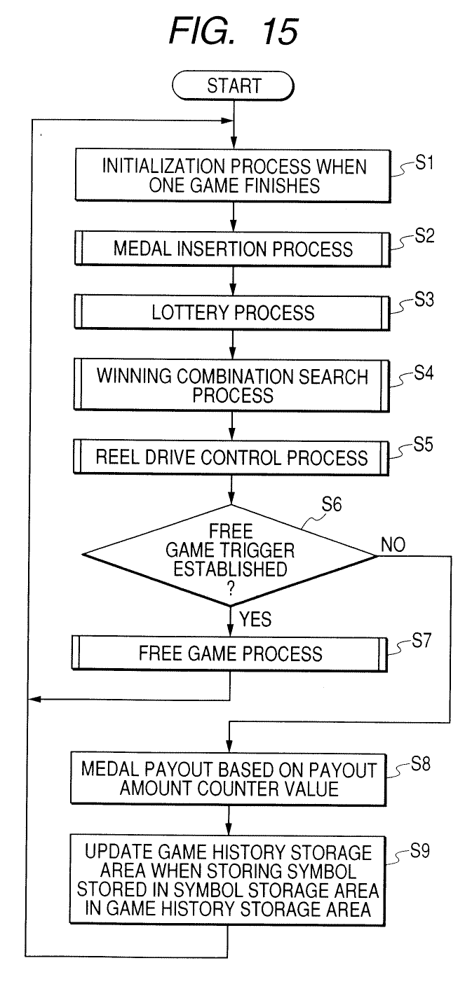

FIG. 15 is a flowchart showing an example of the main process in the slot machine 1.

When the main process starts, the slot machine 1 (more specifically, the main CPU 32) executes a one game finishing time initialization process (S1). In this process, for example, in an initialization condition in which a power switch of the slot machine 1 has been put in an ON condition, the main CPU 32 initializes predetermined data (the data stored in the RAM 33, communication data etc.), In a condition in which the game is being performed, the main CPU 32 deletes parameters (excluding the history information, described later) stored in the RAM 33 at a previous game finishing time, writes parameters to be used in a next game and performs a specification etc. of a start address of a sequence program.

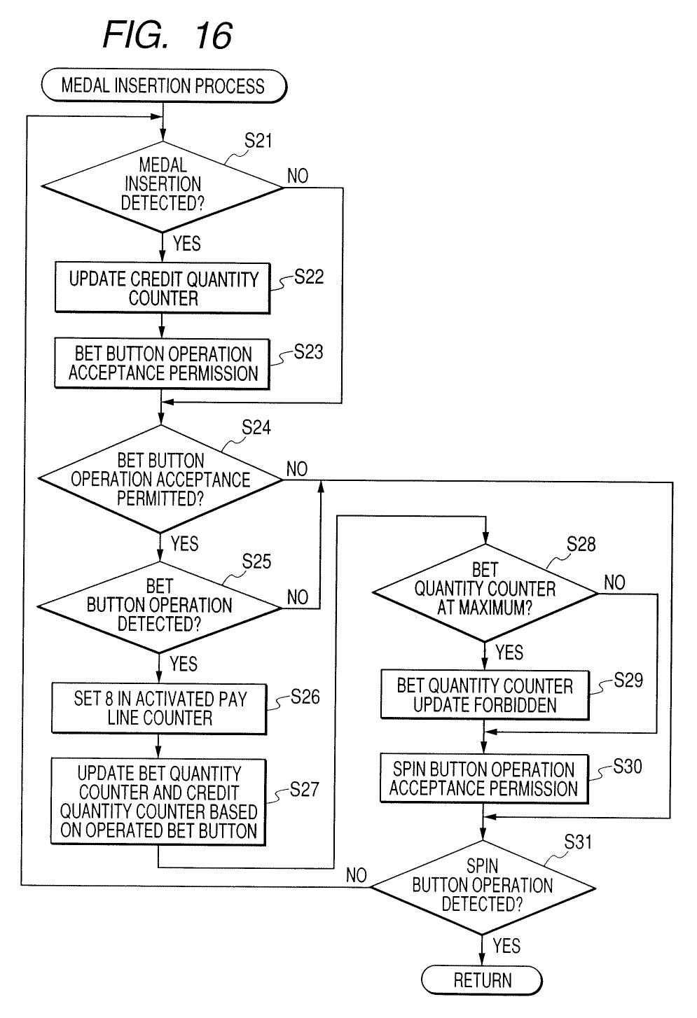

Next, the main CPU 32 performs the medal insertion process (S2). The medal insertion process will be described with reference to a flowchart shown in FIG. 16.

First, the main CPU 32 determines whether the insertion of the medal has been detected by the inserted medal sensor provided in the medal insertion slot 6 (S21). If the insertion of the medal has been detected, a credit quantity counter is updated (S22) and an acceptance of a BET button operation is permitted (S23). Then, if the BET button operation is detected in a condition in which the acceptance of the BET button operation has been permitted, “8” is set in an activated payout line counter (S24 to S26). The activated pay lines here corresponding to the activated pay lines L1 to L8 shown in FIG. 3, all the lines L1 to L8 are activated by the BET operation.

Even if the medal is not inserted in S21, if a predetermined number of medals is in an accredited condition, the BET button operation is accepted regardless (S21: No, S24 to S26).

Continuing, an update process of a BET quantity counter and the credit quantity counter is performed based on the BET button operated (S27). In this operation, if the BET quantity counter has reached a maximum value, the update of the BET quantity counter is forbidden (S28: Yes, S29), and an acceptance of a spin button operation is permitted (S30). Also, in S28, if the BET quantity counter has not reached the maximum, the acceptance of the spin button operation is permitted immediately (S28: No, S30).

Then, when the player operates the spin button 8 and the operation is detected by the spin switch 8a (S31), the medal insertion process finishes and the main CPU 32 proceeds to the lottery process of the main flowchart shown in FIG. 15 (S4). If the player does not operate the spin button 8 in S31, the process of S21 to S31 is repeated.

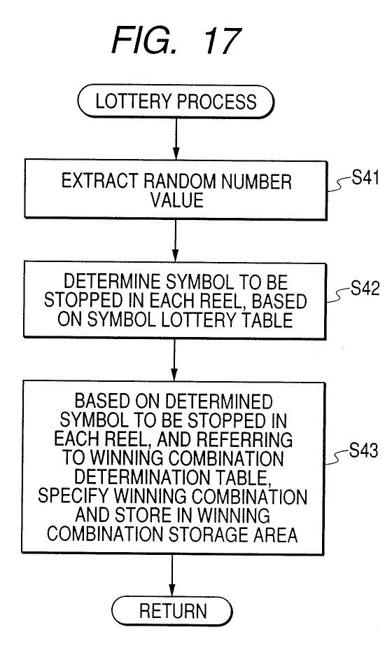

Continuing on from the medal insertion process of S2, the main CPU 32 proceeds to the lottery process (S3). The lottery process will be described with reference to a flowchart shown in FIG. 17.

The lottery process is performed in response to the reception of the signal from the spin switch 8a. The main CPU 32 extracts the random number value via the random number sampling circuit 36 (S41). Next, the symbol to be stopped is determined from the extracted random number value, based on the symbol lottery table prepared in advance (see FIG. 7) (S42). At this time, the determination of the symbol to be stopped is performed a total of nine times, once for each of the variable display portions 22A to 22C, 23A to 23C and 24A to 24C. As a result, the symbols to be stopped are determined for all of the variable display portions 22A to 22C, 23A to 23C and 24A to 24C.

Then, the winning combination is specified based on the symbols to be stopped determined in S42 and referring to the winning combination determination table (FIG. 11), and the specified winning combination is stored in the winning combination storage area of the RAM 33, as shown in FIG. 12 (S43). Accordingly, the lottery process finishes.

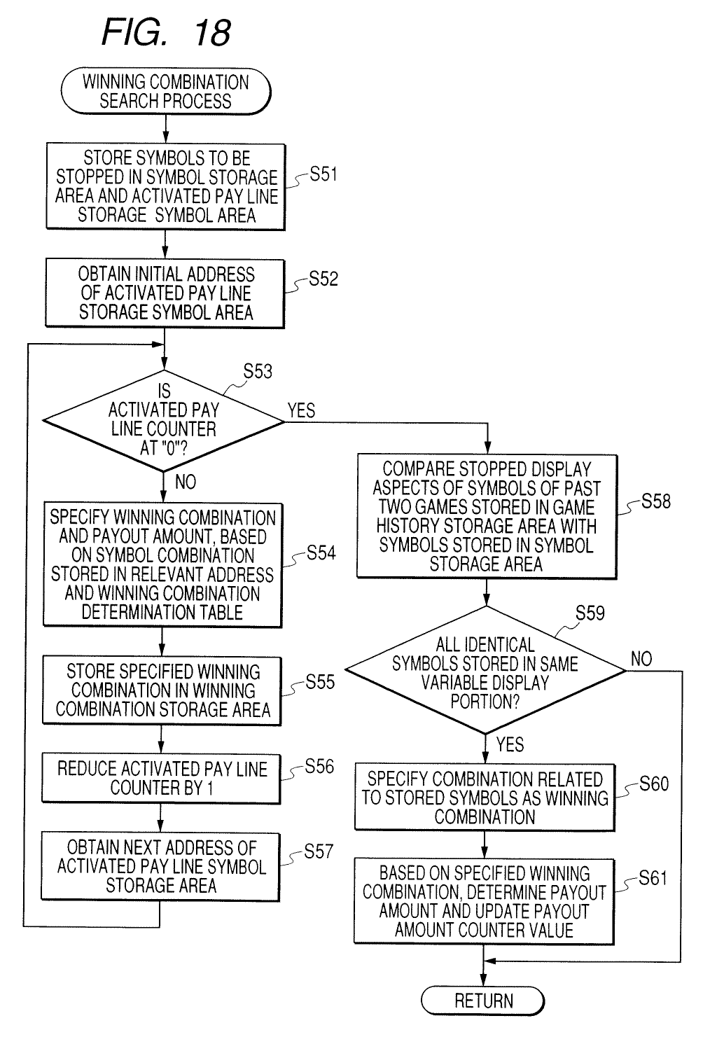

Continuing on from the lottery process of S3, the main CPU 32 proceeds to the winning combination search process (S4). The winning combination search process will be described with reference to a flowchart shown in FIG. 18.

First, the symbols to be stopped, which is determined in S42 in the lottery process described above, are stored in the symbol storage area of the RAM 33 as shown in FIG. 9 and are also stored in the activated pay line symbol storage area of the RAM 33 as shown in FIG. 8 (S51). At this time, a numeric value 8 is set in an activated pay line counter of the RAM 33.

Next, the main CPU 32 obtains an initial address (an address 101) stored in the activated pay line symbol storage area of the RAM 33 shown in FIG. 8 at S51. Then, the main CPU 32 specifies the winning combination and payout amount based on the winning combination determination table shown in FIG. 11 and also based on a combination of symbols by activated pay line specified by the address (S52 and S54). At this time, the winning combination information is stored in the winning combination storage area of the RAM 33, as shown in FIG. 12 (S55). This process is executed for all the addresses (all the activated pay lines L1 to L8). That is, after the process of S55, a value of the activated pay line counter set in S51 described above is reduced by one (S56), then a next address (an address 102) stored in the activated pay line symbol storage area is obtained, and this is repeated until the activated pay line counter reaches zero (S53 to S57).

In the aspect shown in FIG. 8, when executing the winning combination search process S4 with respect to an address 104, since a set of the symbols “BELL” is completed on the activated pay line L4, the winning combination of “BELL”s is established. Therefore, the payout amount 8 is determined from the winning combination determination table of FIG. 11, and the numeric value 8 is set in a payout amount counter of the RAM 33.

In S53 described above, when the activated pay line counter has reached zero, that is, after the specification process of the winning combination and the payout amount has finished for all of the activated pay lines (S53: Yes), continuing on, a confirmation process of the history information is executed.

In the confirmation process, the main CPU 32 compares aspects of the stopped symbols of the preceding two games stored in the game history storage area shown in FIG. 10 with the symbols stored in the symbol storage area in S51 (S57) described above. Then, the main CPU 32 determines whether the identical symbol is stored in the same variable display portion (S58). If the identical symbol is stored in the same variable display portion for three successive games, the main CPU 32 specifies the symbol as the winning combination (S59: Yes, S60). Then, the main CPU 32 specifies the payout amount based on the specified winning combination and with reference to the winning combination determination table shown in FIG. 11 and updates the value of the payout amount counter (S61).

In the aspects shown in FIG. 9 and FIG. 10, the “ORANGE” symbol is stopped in the variable display portion 22C (the reel C on a central right side of the main display 3) for three successive games. In the winning combination search process in this game, in addition to the winning combination of “BELL”s, the winning combination of “OPANGE”s is also established. The player can obtain the payout based on the winning combination of “BELL”s and, at a same time, can obtain the payout based on the winning combination of “ORANGE”s. That is, the player can receive the privilege based on the history.

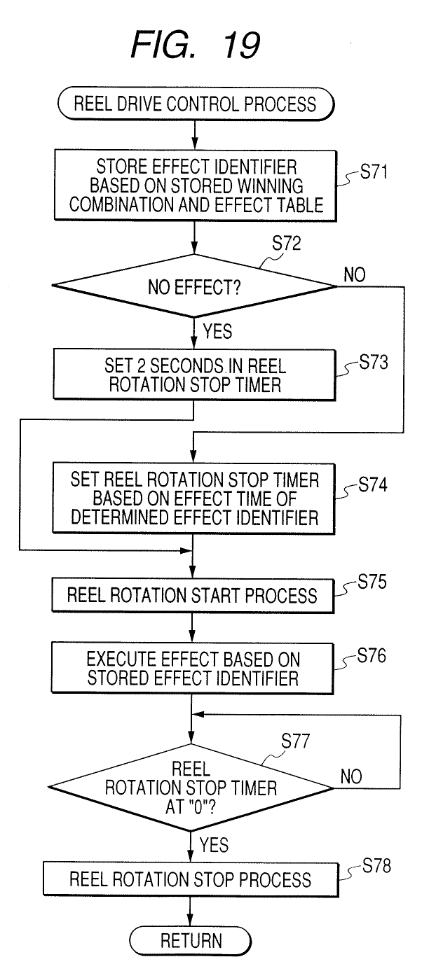

Continuing on from the winning combination search process of S4, the main CPU 32 proceeds to a reel drive control process (S5). The reel drive control process will be described with reference to a flowchart shown in FIG. 19.

First, the main CPU 32 specifies an effect identifier based on the winning combination stored in the winning combination storage area at S55 described above and also based on the effect table shown in FIG. 14. Then, the main CPU 32 stores the specified effect identifier in the RAM 33 (S71). If there is no effect identifier (if the effect is not performed), the main CPU 32 sets two seconds in a reel rotation stop timer. The main CPU 32 executes a reel rotation process (S72: Yes, S73 and S75), and the two seconds have elapsed, the main CPU 32 executes a reel rotation stop process (S77 and S78).

Meanwhile, if there is an effect identifier, the main CPU 32 sets an effect time specified in the effect table shown in FIG. 14 in the reel rotation stop timer and executes the reel rotation process (S72: No, S74 and S75). In this case, the effect image correlated to the effect identifier and stored in advance is selected, the selected effect image is displayed for a corresponding time on the main display 3 or the sub-display 4, and then the reel rotation stop process is executed (S76 to S78).

In the reel drive control process, as in the effect table shown in FIG. 14, a probability of the effect fixed in advance corresponding to the winning combination is performed is high. Therefore, depending on the effect performed when the reel is rotation driven, the player is able to predict a certain level of the winning combination. Further, since there may be a case of not winning even though that kind of effect is performed (a so-called bogus effect) or a case of winning even though the effect is not performed, a heightening of interest is achieved.

Continuing on from the reel drive control process of S5, the main CPU 32 determines whether a free game trigger is established (S6). If the free game is not established, the medal payout process (S8) is executed immediately based on the value of the payout amount counter specified in S61 of the winning combination search process. Then continuing on from the medal payout process, the main CPU 32 executes the update process of the history information stored in the game history storage area (see FIG. 10) of the RAM 33. The update process is performed by: storing the symbol information stored in the symbol storage area (see FIG. 9) into the game history storage area as storage symbols of a first previous game (immediately preceding game) as the history information; storing storage symbols of the first previous game stored in the game history storage area into the game history storage area as storage symbols of a second previous game (the game before the first previous game); and clearing storage symbols of the second previous game in the game history storage area (S9).

When this process is finished, the main CPU 32 returns again to S1 described above in order to execute a next game process.

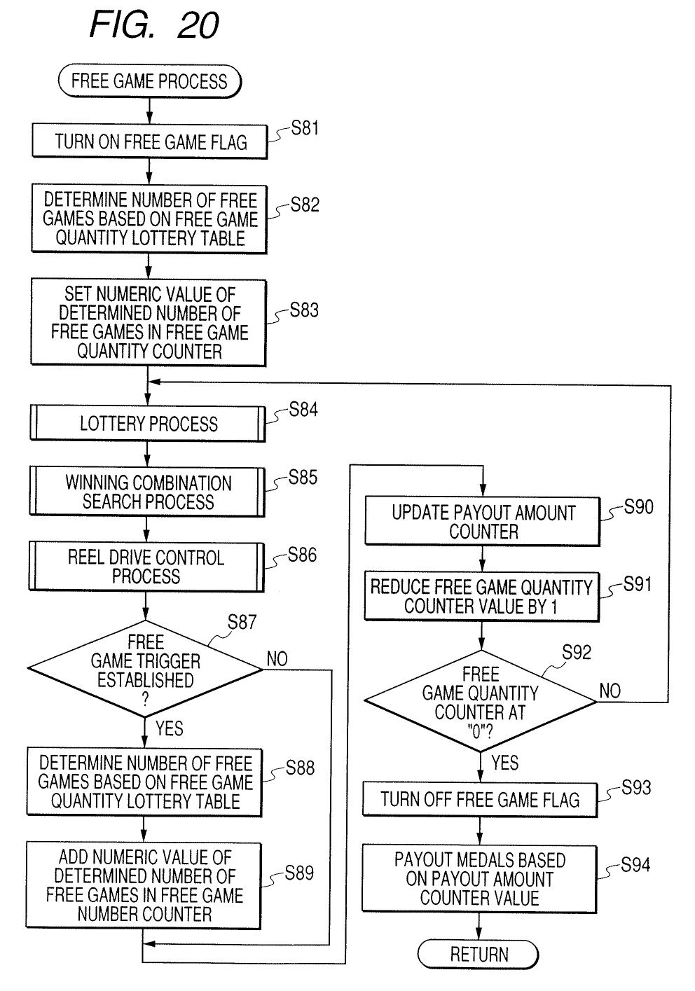

In the process of S6, if the free game trigger is established, the free game process is executed. As described above, the free game is established when a set of the “APPLE” symbols is completed as the winning combination on any one of the activated pay lines, and the free game grants a right to the player to play the game the predetermined number of times without inserting the medal. Hereafter, a procedure of the free game process will be described with reference to a flowchart shown in FIG. 20.

When executing the free game process, the main CPU 32 turns on a free game flag and, by means of the lottery process, determines the number of free games based on the free game quantity lottery table (see FIG. 13) (S81 and S82). A numeric value of the number of free games determined by the lottery process is set in the free game quantity counter of the RAM 33 (S83).

Continuing on, the lottery process, the winning combination search process and the reel drive control process are executed in accordance with a game operation of the player (S84 to S86). These processes are performed in accordance with the above described flowcharts shown in FIGS. 17, 18 and 19 respectively.

Then, after the reel drive process of S86 (S71 to S78) is finished, the main CPU 32 determines whether the free game trigger is established (S87). That is, during the free game presently being executed and if the winning combination is again established by the “APPLE” symbols being aligned on any one of the variable display portions in the process procedures of S84 to S86 (S87: Yes), the free game trigger is established. In this case, the number of free games is determined by the lottery process based on the free game quantity lottery table (see FIG. 13) (S88), and the determined number of free games is added to the free game quantity counter (S89). That is, even in a case where the free game is established during a playing of the free game, a right of the free game that is newly established is added to the right of the free game that is presently executed. Therefore, it is possible for the player to obtain a greater profit.

Then, the main CPU 32 stores and updates a number of medals obtained during the process procedures of S84 to S86 (S90) and subtracts one from the free game quantity counter (S91). The above described free game is executed until the free game quantity counter reaches zero (the number of times obtained by the lottery process) (S92: No, S84 to S92). If the free game quantity counter reaches zero, the free game flag is turned off (S92: Yes, S93).

Subsequently, the main CPU 32 performs a payout process of the medals (the value of the payout amount counter) obtained in the free game according to the above described procedure (S94) and the free game is finished. That is, the medals obtained during the free game are paid out at one time at a point at which the free game is finished.

According to the slot machine including the game procedure described above, the game history (the stopped symbols) is stored for the duration of the plurality of games (three games in the embodiment). If the condition that the game history is of the predetermined aspect (the identical symbol is stopped in the same variable display portion three successive times), the player is provided with a privilege of establishing the symbol as the winning combination. Therefore, it is possible to create a highly interesting, varied gaming experience. That is, in a gaming machine that concludes a play in one game, in the event that the loss is established in that game, the player executes the next game without having any kind of expectation. However, according to the slot machine including the game procedure as described above, even in the event of the loss, the contents of the game can be used to advantage in the next game. Therefore, bearing a past game condition in mind, the player can feel a sense of expectation in every game. Also, the profit is provided in view of the game history, so that the interest increases, and it is possible to increase an operation rate of the playing machine.

Although the description has been given of the embodiment of the invention, the invention is not limited to the above described embodiment and can be implemented in a variety of forms such as described hereafter.

It is also acceptable that the procedure which provides the privilege to the player when the aspect of the game history described above is the predetermined aspect is performed only during the free game. According to this configuration, it is possible to further heighten a feeling of excitement when transferring to the special game and also possible to make the special game a gaming condition with a higher premium.

Also, as shown in FIG. 21, it is also acceptable to display a past stopped condition in the variable display portions on, for example, the sub-display 4. By image displaying a past game history in this way, the player will play the game while having a greater interest in the past game history. Regarding the game history, it is acceptable to provide the privilege based on two games, i.e., the current game and first previous game. It is also acceptable to provide the privilege based on the game history over the duration of four games or more.

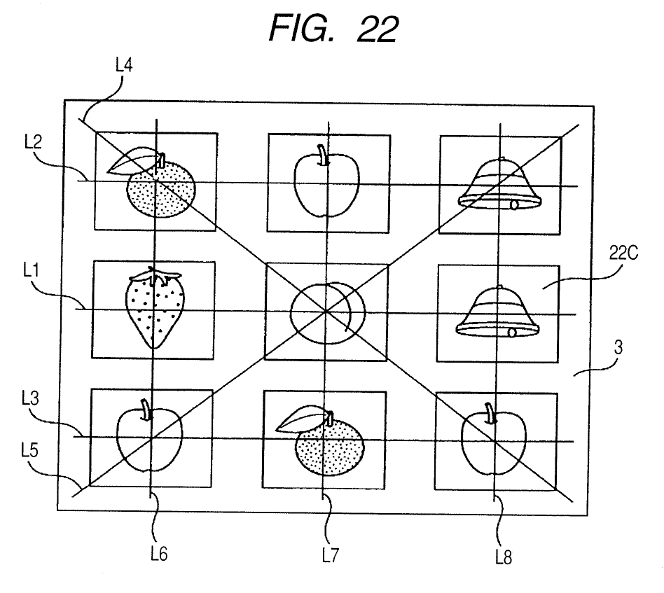

In the embodiment, although the privilege is provided on the condition that the identical symbol is stop-displayed consecutively in any one of the plurality of variable display portions, it is also acceptable that this should take place only in a specified variable display portion (for example, the top right variable display portion 23C). Also, although the privilege has been provided on the condition that the identical symbol is displayed consecutively, it is also acceptable that the privilege is provided, for example, when a previously fixed combination (for example, cherry=>bell=>orange) occurs in a variable display portion. Alternatively, it is also acceptable to obtain the history information by changing a position of a subject variable display portion. For example, as subject variable display portions, as shown in FIG. 21, the variable display portion 22A is selected in a game before the first previous game and the variable display portion 22B is selected in the first previous game, and as shown in FIG. 22, the variable display portion 22C is selected in the current game. The privilege is provided on the condition that the identical symbol (the bell symbol) stops consecutively in the subject variable display portions (the bells are established as the winning combination).

Also, regarding the privilege provided to the player based on the game history, apart from additionally providing the winning combination and paying out the medal as described above, it is also acceptable to make it a transition condition of the free game (the bonus game) described above. Alternatively, it is possible to appropriately modify the privilege, such as increasing the number of reels displayed on the main display 3 and/or allowing an execution of a game other than the game of the rotatable reels.

In this way, by variously changing an aspect of the game history such as a stopping position of the symbols, kinds of the symbol, a relationship between history symbols in the past games, it is possible to provide a more interesting gaming machine.

Furthermore, in the above embodiment, the slot machine having nine variable display portions has been exemplified as the gaming machine, but it is also acceptable that it is a so-called three reel slot machine or five reel slot machine, having three or five variable display portions. It is also acceptable that a variable display unit includes mechanical reels. Also, the invention can be applied to a gaming machine other than the slot machine, such as, for example, a card game machine or a pachinko machine.

According to the embodiment of the invention, the gaming machine includes the plurality of variable display portions. A winning combination is established when a combination of symbols displayed on the variable display portions is a predetermined condition in one game, and a payout process of an award (e.g., the game medium) to the player is performed. A symbol combination aspect in the one game is to be stored as the game history in the symbol storage unit. If a symbol combination aspect determined in a current game that is presently performed and the symbol combination aspect stored as the game history are a predetermined aspect, the privilege is provided to the player. The privilege includes, for example, a right to pay out a large amount of the playing medium to the player when the current game finishes, a right capable of transferring to a bonus game in which a larger amount of the playing medium can be obtained, etc.

Since a connection is provided between stopped symbol aspects over a plurality of games in this way, it is possible for the player to execute the current game while bearing in mind not only the current game but also a result of a previous game condition. Therefore, a highly interesting and varied gaming experience is created. Also, even if the current game results in a loss, a result thereof can be used to advantage from a next game onwards. Therefore, it is possible to heighten a feeling of expectation.

Also, the gaming machine may include an image display that displays a symbol aspect stored as the game history.

Accordingly, a past condition of stopped symbols in the variable display portions is displayed on an image display device such as a liquid crystal display device, the player can immediately see past history information and can enjoy the current game while having a greater interest in a past game history.

Also, a normal game and a special game that is advantageous to the player compared to the normal game are provided as a condition of the game, and the provision of the privilege is executed during the special game.

Accordingly, when the special game (for example, a bonus game such as a free game or the like) is established while the normal game is being executed, the player can obtain a profit of the above privilege. Therefore, it is possible to further heighten a feeling of excitement when transferring to the special game, and an interest can be further increased.

According to the embodiment of the invention, the gaming machine provides a connection between aspects of symbols over a plurality of games, so that a highly interesting and varied gaming experience can be created.

What is claimed is:

1. A gaming machine comprising:
a symbol display unit configured to display a plurality of symbols respectively on a plurality of variable display portions;
a start signal outputting unit configured to output a start signal to start a game;
a symbol varying unit configured to vary the plurality of symbols displayed on the symbol display unit in response to the start signal;
a symbol determination unit configured to determine a plurality of symbols to be displayed on the plurality of variable display portions as a determination result;
an award providing unit configured to provide an award based on a combination of the plurality of symbols in the determination result;
a symbol storage unit that stores a game history including the determination result that has been determined for at least one previous game, the previous game being performed before a current game; and
a privilege providing unit configured to provide a privilege based on a relationship between the determination result of the current game and the game history.

2. The gaming machine according to claim 1, further comprising an image display unit configured to display the determination result of the game history.

3. The gaming machine according to claim 1, wherein the game includes a normal game and a special game that is advantageous to a player compared to the normal game.

4. The gaming machine according to claim 3, wherein the privilege providing unit is activated only during the special game.

5. The gaming machine according to claim 3, wherein the normal game is performed only when a bet is placed.

6. The gaming machine according to claim 3, wherein the special game is performed without placing a bet.

7. The gaming machine according to claim 3, wherein the privilege includes an execution of the special game for at least one subsequent game.

8. The gaming machine according to claim 1, wherein the privilege includes an extra award in addition to the award determined by the award determination unit.

9. The gaming machine according to claim 1, wherein the privilege includes an increase of at least one symbol to be displayed for at least one subsequent game.

10. The gaming machine according to claim 1, wherein the privilege providing unit provides the privilege if at least one of the plurality of symbols in the determination result of the current game and at least one of the plurality of symbols in the game history establish a predetermined combination.

11. The gaming machine according to claim 10, wherein the privilege providing unit provides the privilege if the determination result of the current game and the game history respectively include symbols of a same kind.

12. The gaming machine according to claim 11, wherein the privilege providing unit provides the privilege if the symbols of the same kind are displayed on a same variable display portion.

13. The gaming machine according to claim 10, wherein the privilege providing unit provides the privilege if the symbols displayed on an identical variable display portion in the determination result of the current game and the game history establish a predetermined combination.
